(19) United States
(12) Patent Application Publication
(10) Pub. No.: US 2002/0043107 A1
(43) Pub. Date: Apr. 18, 2002

(54) Copper face rust-inhibiting film thickness measuring method and apparatus

(76) Inventors: Masayoshi Kubo, Ushiku-shi (JP); Hiroyuki Ikeda, Ushiku-Shi (JP)

Correspondence Address: FOLEY AND LARDNER, SUITE 500, 3000 K STREET NW, WASHINGTON, DC, 20007, US

(21) Appl. No.: 09/977,201

(22) Filed: Oct. 16, 2001

(30) Foreign Application Priority Data
Oct. 16, 2000 (JP) 2000-315464

(51) Int. Cl. G01N 29/04; G01M 7/00

(52) U.S. Cl. 73/588

(57) ABSTRACT

Disclosed are a method and apparatus which can easily measure the thickness of a rust-inhibiting film, provided on a copper surface. The method for measuring the thickness of a rust-inhibiting film, provided on a copper surface by using a rust-inhibiting processing liquid, comprises depositing a copper film on the surface of a crystal vibrator; immersing the copper film of the crystal vibrator in a rust-inhibiting processing liquid; and measuring change in the number of vibrations of the crystal vibrator caused by growth of the rust-inhibiting processing liquid on the copper film. The apparatus for measuring the thickness of a rust-inhibiting film, provided on a copper surface by using a rust-inhibiting processing liquid, comprises a crystal vibrator having a copper film deposited on a surface thereof; and a measuring unit which measures the thickness of the rust-inhibiting film on the copper film by measuring change in the number of vibrations of the crystal vibrator.

### BACKGROUND

1. Field of the Invention

The present invention relates to a method and apparatus for measuring the thickness of a rust-inhibiting film which protects a copper face, and more particularly relates to the method and apparatus for measuring the thickness of a rust-inhibiting processing film of a copper face in a printed board and the like.

2. Related Art

A circuit pattern in a printed board is formed by etching of a copper foil layer which is pasted onto the board. Therefore, the copper foil layer must be protected in order to prevent damage to the circuit pattern.

The copper foil layer is covered by a rust-inhibiting film using a rust-inhibitor known as a preflux. This preflux is attracting a great deal of attention, particularly as a surface-processing film which is provided on the copper face of a f lexible printed circuit board (FPC) in flip-chip mounting of electronic components thereon.

To achieve and maintain the capability of the preflux, it is important to control the thickness of the film, which is measured by the following sequence of steps.

(1) Cut a prefluxed copper sheet to a predetermined size.

(2) Immerse the copper sheet in concentrated hydrochloric acid, and sufficiently melt the rust-inhibitor on the surface.

(3) Measure light-absorption corresponding to the wavelength of the main element of the melted rust-inhibitor liquid by using an infrared spectrophotometer.

(4) Convert the absorption value to a film thickness by using a pre-existing computational equation.

Consequently, considerable work and time is consumed in performing one measurement, allowing no more than approximately one or two measurements to be made in one day.

This measuring method is not suitable for use in mass production.

### SUMMARY OF THE INVENTION

The present invention has been realized in consideration of the above points, and aims to provide a method and apparatus which can easily measure the thickness of a rust-inhibiting film on a copper face.

To achieve the above objects, the present invention provides a method for measuring the thickness of a rust-inhibiting film, provided on a copper surface by using a rust-inhibiting processing liquid. The method comprises depositing a copper film on the surface of a crystal vibrator; immersing the copper film of the crystal vibrator in a rust-inhibiting processing liquid; and measuring change in the number of vibrations of the crystal vibrator caused by growth of the rust-inhibiting processing liquid on the copper film.

The present invention further provides an apparatus for measuring the thickness of a rust-inhibiting film, provided on a copper surface by using a rust-inhibiting processing liquid. The apparatus comprises a crystal vibrator having a copper film deposited on a surface thereof; and a measuring unit which measures the thickness of the rust-inhibiting film on the copper film by measuring change in the number of vibrations of the crystal vibrator.

### BRIEF DESCRIPTION OF THE DRAWINGS

FIG. 1 is a diagram showing a system for measuring the thickness of a rust-inhibiting film on a copper surface according to the present invention;

FIG. 2 is a perspective view of the outside of the unitized body of a sensor S; and

FIG. 3 is a diagram showing measurements of change in the thickness of the rust-inhibiting film in the measuring system of the present invention.

### DESCRIPTION OF THE PREFERRED EMBODIMENTS

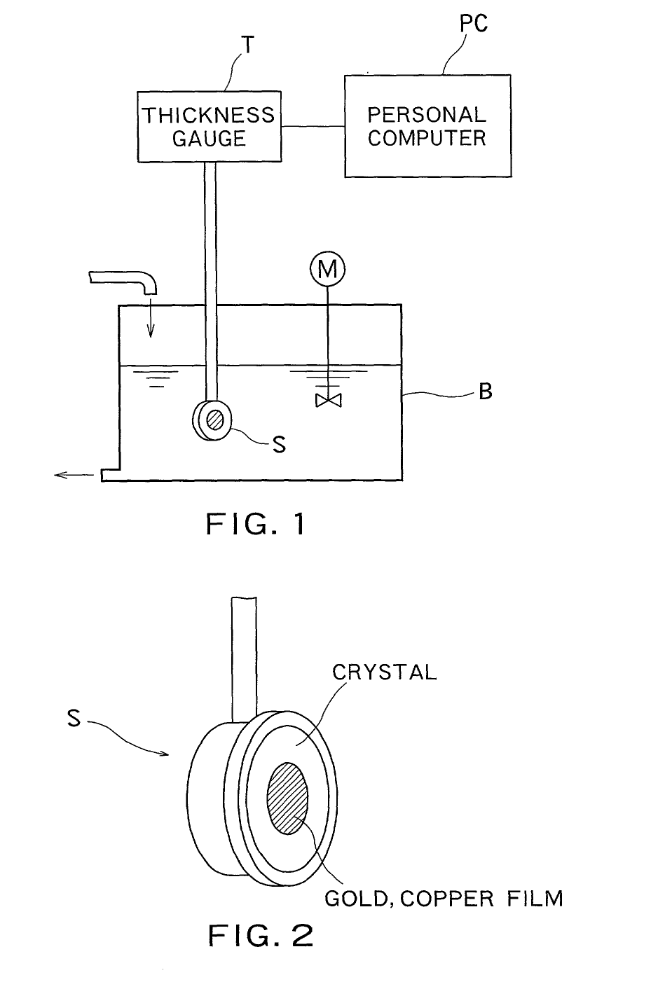

FIG. 1 shows a measuring system for measuring the thickness of a rust-inhibiting film on a copper surface in this invention. According to this measuring system, a sensor S, which a copper film is provided on, is immersed in a bath B, which is filled with a rust-inhibitor; a thickness gauge T changes in accordance with change in the thickness of the rust-inhibiting film, provided on the sensor S, and outputs to a personal computer PC. In the bath B, the liquid rust-inhibitor is agitated by an agitator M during measuring, and discharged after measuring. After measuring, the rust-inhibitor film is removed from the sensor S and the bath B is cleaned in preparation for subsequent measuring.

The preflux comprises a heat-resistant protection film, and is formed when Alkylbenzimidazole, the main element in the rust-inhibitor, reacts with the copper film surface of the printed board, forming a coordination on the surface.

Accordingly, a copper film is provided on the surface of the sensor S by using a crystal vibrator, the rust-inhibiting film is provided on the copper film, and the thickness is measured.

FIG. 2 is a perspective view showing the outside of the unitized body of the sensor S. In this sensor S, gold is deposited on part of the outer face of a crystal vibrator, and copper plating is provided thereabove. The sensor S outputs via two lead wires to the thickness gauge (FIG. 1).

When the sensor S is immersed in the rust-inhibitor, thereby forming the preflux (i.e. rust-inhibiting film), the mass of the sensor S slightly increases by an amount equivalent to the rust-inhibiting film. Since this increase in the mass affects the number of vibrations of the crystal vibrator, change in the thickness can be detected as change in the number of vibrations.

When Δm represents the very small change in mass per unit area of the crystal vibrator, and Δf represents the very small change in the number of resonance vibrations of the crystal vibrator, the following relationship, known as a Sauerby equation, is established between the two.

Δm/Δf=−(μρ)^{½}/(2fs²)

where fs : resonant frequency (Hz) of the crystal vibrator prior to the rust-inhibiting process

μ: rigidity of the crystal=2.95×10¹¹ (g·cm⁻¹·s⁻²)

ρ: density of the crystal=2.65 (g·cm⁻³)

In this way, the thickness of the rust-inhibiting film can be measured by using the fact that the number of vibrations changes when the mass of the crystal vibrator changes after the rust-inhibiting film has been provided.

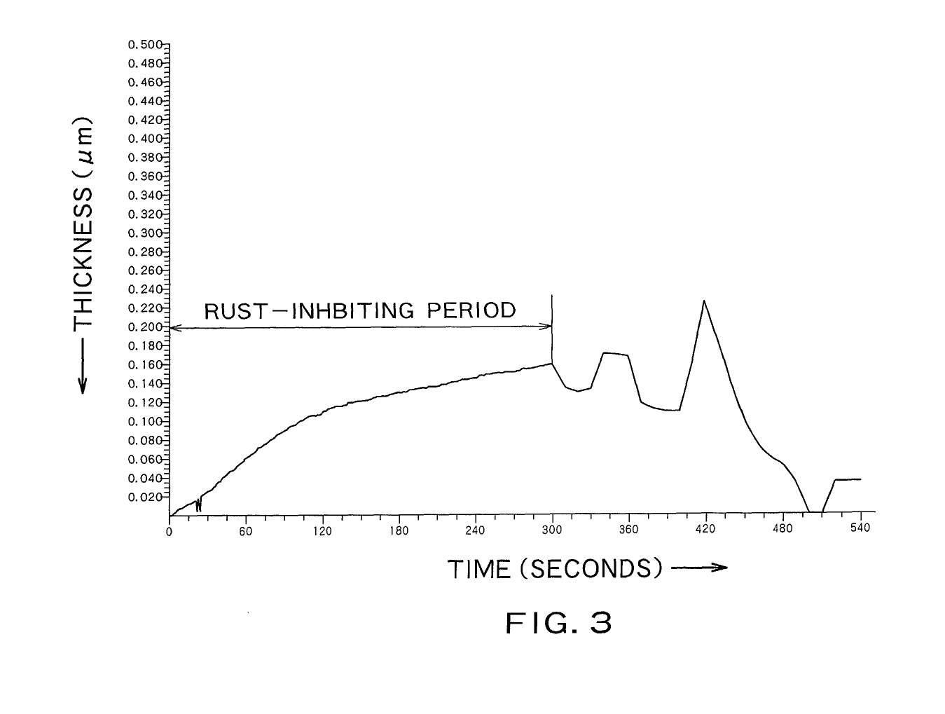

FIG. 3 shows examples of measurements of change in the thickness of the rust-inhibiting film obtained by using the measuring system of this invention. As shown by these measurements, the relationship between time and film-thickness is almost directly proportional for approximately 120 seconds after measuring starts. Thereafter, the increase in the thickness of the rust-inhibiting film decreases, and at approximately 300 seconds a rust-inhibiting film of approximately 0.16 m is formed on the copper face.

By performing the rust-inhibiting film process while referring to these measurements, the thickness of the rust-inhibiting film can be more accurately controlled. As a result, damage to the circuit pattern on the printed board can be prevented, increasing the reliability of the printed board.

As described above, according to the present invention, a copper film is provided on the surface of a crystal vibrator, and a rust-inhibiting film comprising a rust-inhibitor is provided on the copper film. The resultant change in the mass is detected as change in the number of vibrations of the crystal vibrator, and the thickness of the rust-inhibiting film is thereby measured. Therefore, the thickness of the rust-inhibiting film can be measured more easily than in conventional methods, and more accurate measurements can be obtained.

What is claimed is:

1. A method for measuring the thickness of a rust-inhibiting film, provided on a copper surface by using a rust-inhibiting processing liquid, comprising the steps of:
depositing a copper film on the surface of a crystal vibrator;
immersing said copper film of said crystal vibrator in a rust-inhibiting processing liquid; and
measuring change in the number of vibrations of said crystal vibrator caused by growth of said rust-inhibiting processing liquid on said copper film.

2. An apparatus for measuring the thickness of a rust-inhibiting film, provided on a copper surface by using a rust-inhibiting processing liquid, comprising:
a crystal vibrator having a copper film deposited on a surface thereof; and
a measuring unit which measures the thickness of a rust-inhibiting film on said copper film by measuring change in the number of vibrations of said crystal vibrator.

3. The apparatus according to claim 2, wherein a gold film is deposited on the surface of said crystal vibrator, and a copper plating film is provided thereabove.
